(19) United States
(12) Patent Application Publication
(10) Pub. No.: US 2026/0126348 A1
(43) Pub. Date: May 7, 2026

(54) ROADWAY SIMULATOR TESTING ASSEMBLY

(71) Applicant: Illinois Tool Works Inc., Glenview, IL (US)

(72) Inventor: Victor Senft, Edina, MN (US)

(21) Appl. No.: 19/377,324

(22) Filed: Nov. 3, 2025

Related U.S. Application Data
(60) Provisional application No. 63/716,510, filed on Nov. 5, 2024.

(51) Int. Cl. G01M 17/007; G01J 5/00

(52) U.S. Cl. CPC G01M 17/0074; G01J 5/0022

(57) ABSTRACT

A roadway simulator and method configured to simulate a heated roadway. A continuous belt is supported by a first roller such that the continuous belt moves about the first roller and a spaced apart second roller. The belt is configured to be under at least a portion of a vehicle. The belt is heated or cooled to a selected temperature and rotated to simulate movement of the vehicle along a road at a selected speed at the selected temperature. One or more parameters of the vehicle can be monitored due to the presence of the heated continuous belt.

### CROSS-REFERENCE TO RELATED APPLICATIONS

The present application is based on and claims the benefit of U.S. provisional patent application Serial No. 63/716,510, filed November 5, 2024, the content of which is hereby incorporated by reference in its entirety.

### BACKGROUND

The discussion below is merely provided for general background information and is not intended to be used as an aid in determining the scope of the claimed subject matter.

The present disclosure relates to a roadway testing assembly that allows, for example, a vehicle to simulate traveling along a road in a substantially stationary position while sensing or monitoring selected variables on the vehicle. More particularly, the present disclosure relates to a roadway assembly that is configured to be heated to allow, for example, a vehicle to simulate traveling along a road that has been heated due to ambient conditions.

Electric vehicles (“EVs”) are becoming increasingly popular vehicle for people to drive. Many people chose EVs over fossil fuel powered vehicles because EVs are essentially emission free and do not produce carbon dioxide or other exhaust gasses that can harm the environment.

However, the batteries used to power EVs are heavy and are typically located along a midplane of the vehicle in the direction of travel to provide substantially similar forces on each set of spaced apart wheels. The batteries are also located proximate a transverse midplane so that similar forces are provided between the spaced apart sets of wheels on the EV. Typically, the batteries are also located lower to the ground to cause the center of gravity to be lower to provide better stability.

An issue with the batteries used in EVs is the generation of heat while electric energy is being drawn from the battery and power the EV. At least some of the heat is required to be drawn from the battery while discharging power to prevent the battery from overheating. A typical method of drawing heat from, or cooling the battery, is to transfer heat to the ambient environment as the EV is moving along a road.

However, some environmental conditions where the roadway become sufficiently hot, such as in a desert where road surface temperatures can reach, for example, between and 120°F and 140°F, the transfer of heat to the ambient air is not sufficient to cool the battery due to the proximate location of the battery relative to the heated roadway. The heated roadway can result in a build-up of heat in the batteries, which can result in battery malfunction and/or premature failure.

### SUMMARY

An aspect of the present disclosure relates to a roadway simulator configured to simulate a heated roadway. The roadway simulator also includes a first roller; a second roller spaced from the first roller; a continuous belt positioned about the first roller and the second roller, the continuous belt having an outer surface and an inner surface. An energy source is configured to impart energy into the continuous belt to heat or cool the continuous belt. A temperature sensor is configured to provide a signal relating to a sensed temperature of the continuous belt. A controller is configured to receive the signal from the temperature sensor, determine an error between the sensed temperature on the continuous belt and a setpoint and send a signal to the energy source to adjust an amount of heat imparted into the continuous belt based upon the error.

Implementations may include one or more of the following features. The energy source may include a heat source configured to direct heated air directed toward the continuous belt to convectively heat the continuous belt. Heated or cooled air can be directed through the air bearing to convectively heat or cool the continuous belt. In one embodiment, the selected elevated temperature ranges between about 120 degrees (Fahrenheit) and about 140 degrees (Fahrenheit).

The energy source may include a radiant heater configured to direct radiant energy toward the continuous belt. The radiant heater may include an infrared heater configured to direct radiant energy towards the inner or outer surface of the continuous belt.

The energy source can be located within the first roller and/or the second roller, where the energy source is configured to heat the first roller and/or the second roller, where the continuous belt is heated through conduction due to contact with the first roller and/or the second roller. For instance, the energy source may include resistive heaters within the first roller and/or the second roller. The energy source may include heated air directed into an interior of the first roller and/or the second roller. In another embodiment, heated water is directed through the water/glycol bearing to conductive heat the continuous belt.

The temperature sensor can be embedded or attached to the continuous belt. The temperature sensor can be configured to send a wireless signal to the controller. The temperature sensor may include a non-contact sensor configured to sense a temperature of the continuous belt. The non-contact sensor may include an infrared sensor.

The continuous belt can be heated or cooled across a width thereof, or the continuous belt can be heated or cooled across a portion of a width thereof. The roadway simulator may include a single continuous belt. The roadway simulator may include three or more belts, where an interior belt is disposed between outside belts configured to engage tires of a vehicle and the interior belt is the heated or cooled continuous belt.

Another aspect of the present disclosure relates to a method of simulating a heated roadway. The method includes providing a continuous belt supported by a first roller such that the continuous belt moves about the first roller and a spaced apart second roller; positioning at least a portion of a vehicle over the continuous belt, heating or cooling the continuous belt to a selected temperature, rotating the continuous belt to simulate movement of the vehicle along a road at a selected speed at the selected temperature, and monitoring one or more parameters of the vehicle due to the presence of the heated continuous belt.

Implementations may include one or more of the following features. The selected temperature is cooled below ambient temperature to simulate cold weather road conditions. In one embodiment, the selected elevated temperature ranges between about 120 degrees (Fahrenheit) and about 140 degrees (Fahrenheit) to simulate hot road conditions.

Heating the continuous belt may include directing heated fluid towards the continuous belt through a bearing located between the first roller and the second roller and below the continuous belt. Cooling the continuous belt may include directing cooled fluid towards the continuous belt through a bearing located between the first roller and the second roller and below the continuous belt. Heating the continuous belt may include directing heated fluid towards the continuous belt. Heating the continuous belt may include directing radiant energy toward the continuous belt. Directing radiant energy towards the continuous belt may include directing infrared energy towards an inner or outer surface of the continuous belt.

Heating the continuous belt may include heating the first roller and/or the second roller and conductively heating the continuous belt. Heating the first roller and/or the second roller may include utilizing resistive heaters within an interior of the first roller and/or the second roller. Heating the first roller and/or the second roller may include directing heated air into an interior of the first roller and/or the second roller.

Cooling the continuous belt may include directing cooled water through a water/glycol bearing located between the first roller and the second roller.

The method may include: sensing a temperature of the continuous belt with a sensor, comparing the temperature to the selected temperature, and adjusting an amount of heat imparted into the continuous belt based upon comparing the temperature to the selected temperature.

Sensing the temperature of the continuous belt may include: embedding or attaching a sensor to the continuous belt; and sending a wireless signal relating to the temperature to a controller to compare the temperature to the selected temperature. Sensing the temperature of the continuous belt may include: utilizing a non-contact temperature sensor to determine a sensed temperature of the continuous belt; and sending a signal relating to the temperature to a controller to compare the sensed temperature to the selected temperature. roadway simulator testing assembly.

### BRIEF DESCRIPTION OF THE DRAWINGS

FIG. 1 is a perspective view of an automobile on a single continuous belt roadway simulator.

FIG. 2 is a schematic side view of a roadway simulator wherein the continuous belt is convectively heated.

FIG. 3 is a schematic top view of a roadway simulator wherein the continuous belt is convectively heated.

FIG. 4 isa schematic view of a roadway simulator wherein the continuous belt is radiantly heated.

FIG. 5 is a schematic view of a roadway simulator wherein the continuous belt is conductively heated.

FIG. 6 is perspective view of a five-belt roadway simulator where a middle belt is heated.

FIG. 7 is a schematic view of tire testing device having a heated continuous belt.

### DETAILED DESCRIPTION

The present disclosure relates to a roadway simulator testing assembly that is typically used in a wind tunnel. In one embodiment, the present disclosure includes one or more continuous loop roadway assemblies where the one or more continuous loop roadway assemblies are configured to be heated to a selected temperature to simulate the effects on components of a vehicle, such as but not limited to an electric vehicle, traveling on a road that is heated to an elevated temperature caused by environmental conditions. By way of a non-limiting example, a road in the desert can be heated to temperature range between about 120°F and about 140°F.

Electric vehicles (EVs) utilize batteries to power the EV where the battery or batteries are located proximate a bottom of the EV due to the weight of the battery or batteries to maintain a lower center of gravity. Additionally, the batteries are typically substantially centrally located at least along a midplane in a direction of travel to substantially even loads and forces between the spaced apart front wheels and spaced apart back wheels. In some instances, the batteries are also located proximate a midplane between the front tires and back tires to substantially even the loads incurred by the front tires and the back tires.

However, locating the battery or batteries low to the ground and proximate the midplanes can cause the batteries to excessively heat, which can decrease useful life or cause the battery to malfunction. The excessive heating is caused by the generation of heat as power is supplied to the EV and the lack of ambient cooling caused by the heating of the air proximate the heated road.

In one embodiment, the heated roadway simulator of the present disclosure allows a designer to simulate and evaluate the effects of a heated road on the batteries, or other components, of an EV traveling at different speeds and environmental conditions. The heated roadway simulator also allows a designer evaluate how different configurations of the underside of the EV affect the aerodynamic conditions below and around the underside of the EV while simulate moving the EV along the along the heated road.

The presently disclosed roadway simulator can be used to simulate track conditions for motorsports vehicle testing. By way of non-limiting example, a heated roadway simulator can be used to simulate a heated race track which allows a designer to evaluate the aerodynamic effects on a race car caused by the heated track.

The presently disclosed roadway simulator can also be use to simulate a cooled road surface, such as in the winter season. The cooled roadway simulator allows a designer to evaluate the aerodynamic effects on a vehicle in cooler or cold weather.

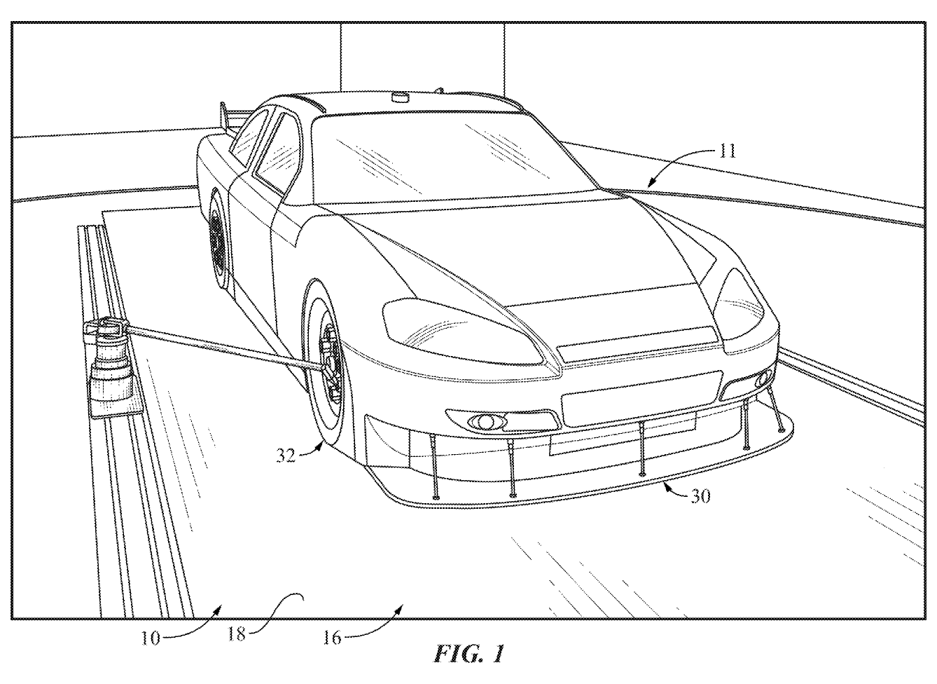

FIG. 1 illustrated a single belt roadway simulator at 10 in a wind tunnel 12. The single belt roadway simulator 10 includes a continuous belt 16 includes an outer surface 18 on which tires 32 of a vehicle 30 rotate to simulate travel at a selected speed and allow for the evaluation of ground effect conditions under the electric vehicle 30 including proximate a battery.

Referring to FIGS. 1-3, the single belt roadway simulator 10 includes a first roller 12 and a roller 14 about which the continuous belt 16 is retained in tension and rotated. An inner surface 20 of the continuous belt 16 engages the first roller 12 and the second roller 14 such that first roller the continuous belt 16 moves with the first roller 12 and the second roller 14. It should be noted that the rollers 12 and/or 14 can be rollers that provide rotational resistance or driven rollers, depending on the needs of testing of the vehicle, such as but not limited to an electric vehicle (EV), although an EV will be referred to for illustrative purposes.

In one embodiment, the vehicle 30 is an EV which can drive rotation of the continuous belt 16 and the rollers 12, 14, wherein the EV batteries supply the necessary power to the EV drive system so as to rotate the continuous belt 16 and rollers 12, 14. Operation of the EV drive system typically causes the batteries to heat up. Depending on the rotational resistance desired, the rollers 12, 14 can be operated as idlers providing inherent mechanical rotational resistance. Alternatively, one or both rollers can provide additional rotational resistance being operatively connected to an electrical generator or motor, operating as a generator, or via a hydraulic or other form of pump that provides resistance. Also, depending on power capabilities of the vehicle being tested, if needed the roller(s) 12, 14 can be driven in part if the vehicle is not capable of rotating the continuous belt 16 and rollers 12, 14 as desired.

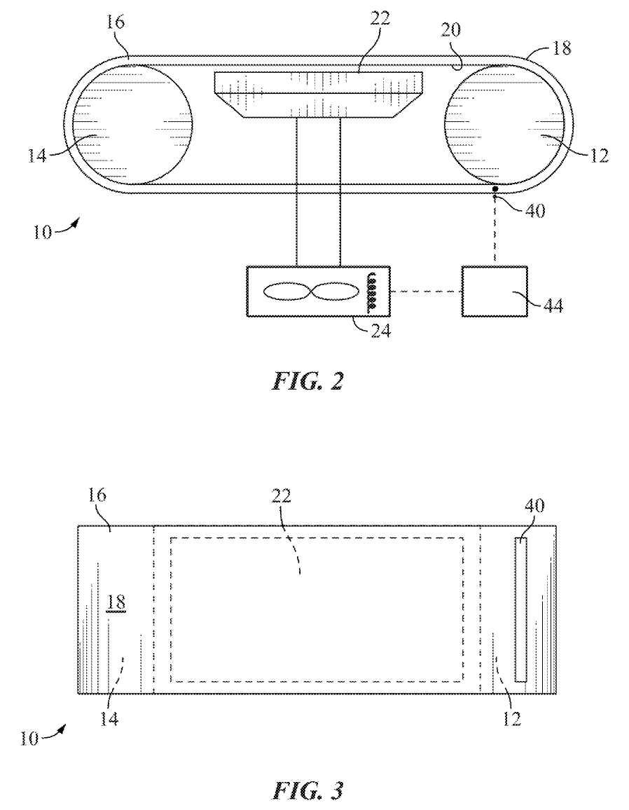

As illustrated in FIGS. 2 and 3, an air bearing 22 is positioned between the first roller 12 and the second roller 14. The air bearing is configured to direct heated or cooled air from a heater/chiller 24 having a fan or blower onto the inner surface 20 to convectively heat or cool the continuous belt 16 to a selected temperature (e.g. above or below ambient temperature) as well as support the continuous belt 16, and the EV if needed during testing.

In another embodiment, a water bearing can replace the air bearing 22. The water bearing can supply heated or cooled liquid to the inner surface 20 of the continuous belt 16. In a non-

limiting example, a water/glycol bearing is located between the first roller 12 and the second roller 14 and below the inner surface 20 of the continuous belt 16. Heated or cooled water is directed through the water/glycol bearing to convectively heat or cool the continuous belt 16.

Whether the continuous belt 16 is heated or cooled, in one embodiment, a temperature sensor 40 is embedded or attached to the continuous belt to determine a temperature of the heated continuous belt 16. A signal 42, such as a wireless signal (e.g. RFID, Bluetooth, etc.), or a wired signal having sliding contacts, brushes or the like, is sent to a controller 44 to determine an error or difference in actual temperature relative to a setpoint. The controller 44 then sends a signal to the heater 24 to adjust the temperature of the air flowing through the air bearing 22 to convectively heat the continuous belt 16. The use of the temperature sensor 40, the controller 44 and the heater/chiller 24 allows a feedback control system to be used to control the temperature of the continuous belt 16 to simulate the EV 30 traveling along a heated or cooled road to evaluate the ground effects and/or other operational parameters under study during the testing of the EV 30 such as but not limited to the battery.

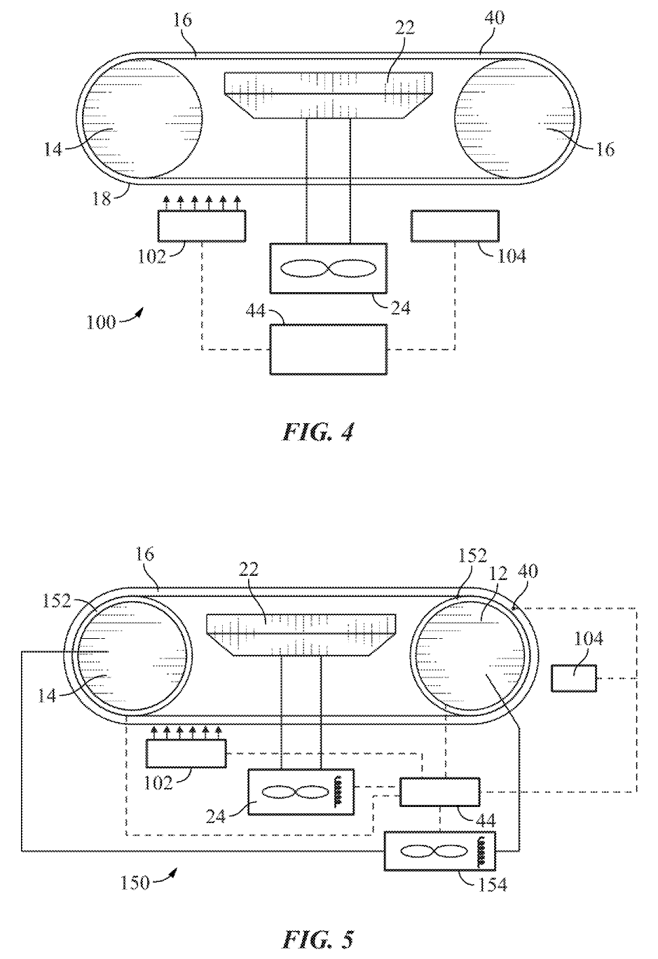

Referring to FIG. 4, another configuration of a single belt roadway simulator is illustrated at 100 that is similar to that of the simulator of FIG. 1. However, instead of using convective heating with hot air through the air bearing 22, a radiant heater 102 is used to impart energy into the continuous belt 16 through the outer surface 18. The temperature of the continuous belt 16 can be sensed by the temperature sensor 40 attached to or embedded in the continuous belt 16. Alternatively, the temperature of the continuous belt 16, in this or any embodiment discussed herein, can be sensed by a contactless sensor 104, such as an infrared sensor. The contactless sensor 102 transmits a signal to the controller 44 to determine an error or difference the sensed temperature relative to the setpoint. The controller 44 then sends a signal to the radiant heater 102 to either increase or decrease the emitted energy into the continuous belt 16, depending upon the determined error. It should be noted a separate heater having a blower can be used to heat the belt 16, if it is not desirable to use the heated air in the air bearing 22. Hence, the heater 102 can represent such a heater having a blower or fan, or a heater that provides both radiant and heater air.

Referring to FIG. 5, another single belt roadway simulator is illustrated at 150. The roadway simulator 150 differs from the roadway simulators 10 and 100 in that conductive heating through the first roller 12 and/or the second roller 14 are heated which in turn conductively heats

the continuous belt 16. In one embodiment, resistive heater(s) 152 are attached to an interior surface of one or both of the first roller 12 and/or the second roller 14. Alternatively, a heater/chiller154 can direct heated or cooled air into the interior of the first roller 12 and/or the second roller 14 to heat or cool the roller(s) 12 and/or 14 and conductively heat or cool the continuous belt 16. The temperature of the belt 16 can be sensed by the attached or embedded sensor 40 or by the contactless sensor 104. A similar feedback control system would be used where a signal is sent to the controller 44 and the controller 44 determines the error of the sensed temperature from a setpoint. The controller 44 then sends a signal to the resistive heaters 152 and/or the heater/chiller 154 to adjust energy imparted into the first roller 12 and/or the second roller 14 which conductively heats or cools the continuous belt 16.

FIG. 5 further illustrates the blower heater/chiller 24, and the heater 102 providing heated or cooled air and/or radiant heating. Hence, it should be understood in one embodiment any combination of blower heater/chiller 24, heater 102, resistive heating elements 152 and heater/chiller 154 can be present.

As illustrated, the continuous belt 16 is heated across a width. However, it is within the scope of the present disclosure to heat a portion of the width of the continuous belt 16 where the battery of the EV 40 would encounter the effects of a heated road.

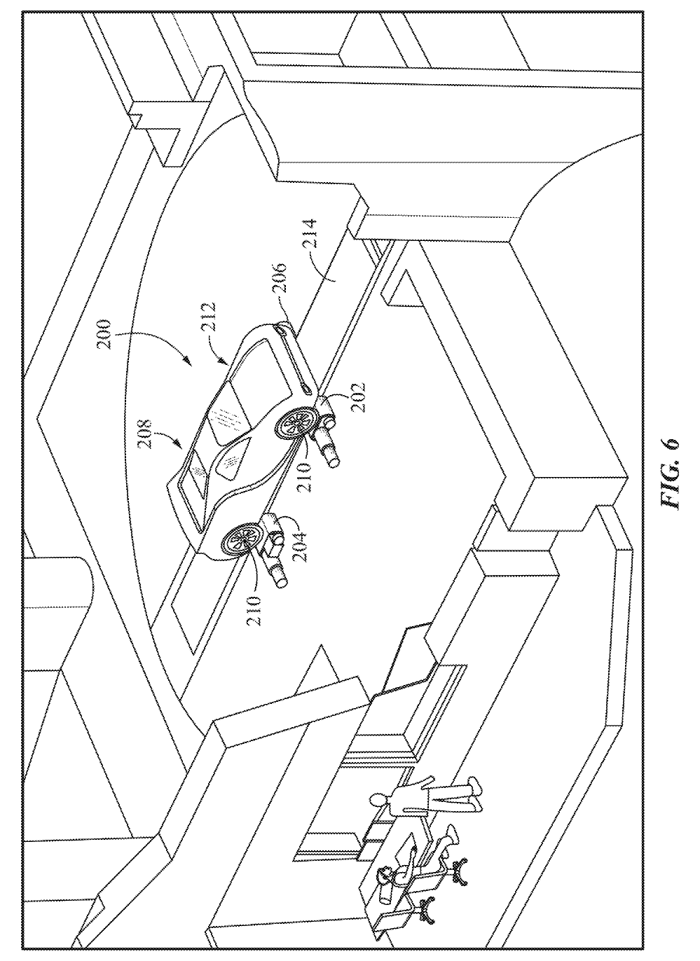

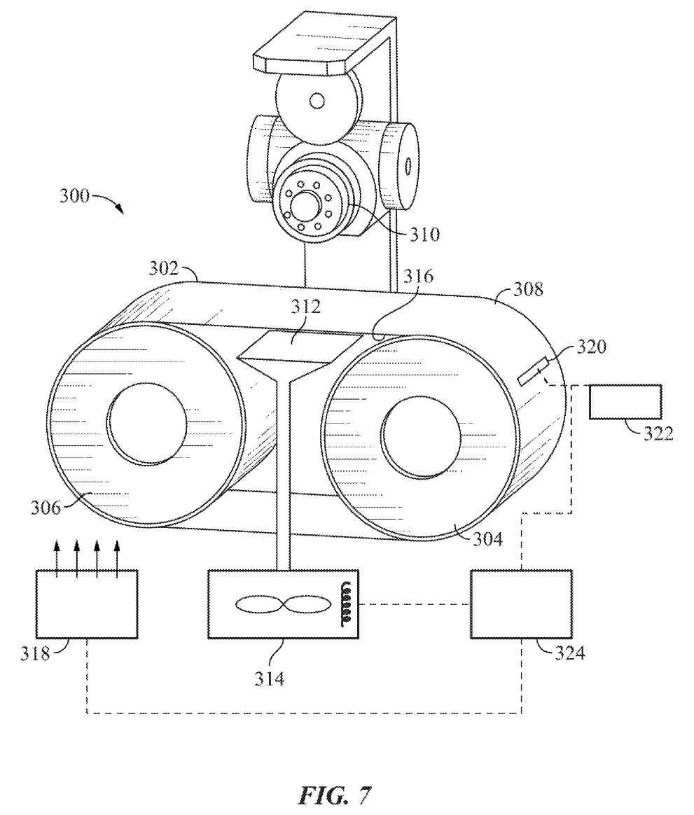

Referring to FIG. 6, another roadway simulator is illustrated at 200. The roadway simulator 200 includes four independently controllable roadway simulators 202, 204, 206 and 208, where each roadway simulator 202, 204, 206 and 208 is similarly constructed to the embodiments 10, 100 and 150. Each roadway simulator 202, 204, 206 and 208 has a belt that engages tires 210 of an EV 212 to simulate the EV 212 traveling along a road at a determined speed. The roadway simulator 200 includes a middle roadway simulator 214 that is configured to be heated to a set point as described with respect to the embodiments described above and illustrated in FIGS. 1-5. The roadway simulator 200 allows the ground effects and/or other parameters of the EV 212 such as the battery to be studied while traveling over a heated road because of the heated belt on the middle roadway simulator 214. One or more of the roadway simulators 202, 204, 206 and 208 may also include heaters as discussed above if desired.

While a five-belt roadway simulator is described with respect to the FIG. 6, it is understood that a three-belt roadway simulator can also be used where passenger side tires engage a single belt of a roadway simulator and the driver side tires engage a spaced apart belt of another roadway

simulator and may include heaters if desired. The middle belt roadway simulator 214 is heated to simulate the EV traveling along a heated road.

FIG. 7 illustrates a tire testing device 300 having a heated continuous belt 302. The tire testing device includes a first roller 304 and a second roller 306 about which the continuous belt rotates. The tire testing device 300 includes a spindle 310 to which a tire is mounted such that the treads of the tire engage an outer surface 308 of the continuous belt 302.

The tire testing device 300 includes an air bearing or a water bearing 312 between the first roller 304 and the second roller 306 where the air bearing is configured to direct heated or cooled fluid (e.g. air, water, water/glycol, etc.) from a heater/chiller 314 towards a lower surface 316 of the belt 302 to convectively heat the continuous belt 302. Alternatively, the continuous belt 302 can be heated using a radiant and/or blower heater 318 that directs radiant energy, such as infrared energy, and/or convective energy, towards a surface 308, such as but not limited to an outer surface, of the continuous belt 302. Also, alternatively, the first roller and/or the second roller can be heated to conductively heat the continuous belt 302 through contact as discussed above.

A temperature sensor 320 can be embedded or attached to the continuous belt 302 where a wireless or wired signal is sent relative to the sensed temperature. Alternatively, a contactless temperature sensor 322 such as an infrared sensor can be utilized to sense the temperature of the continuous belt 302.

A controller 324 receives the signals relative to the sensed temperature and compares the sensed temperature to a setpoint temperature to determine an error. The error is then used to modify the energy imparted into the continuous belt 302, whether through convection, radiation or conduction, to adjust the temperature to be closer to the setpoint.

Maintaining the continuous belt 302 proximate the elevated temperature setpoint and controlling the relative speed of the tire allows data to be collected about the performance of the tire on a heated road, such as in a desert. Alternatively, maintaining the continuous belt 302 proximate a lowered temperature setpoint and controlling the relative speed of the tire allows data to be collected about the performance of the tire on a cooled road, such as during winter.

Although the present disclosure has been described with reference to preferred embodiments, workers skilled in the art will recognize that changes may be made in form and detail without departing from the spirit and scope of the disclosure.

What is claimed is:

1. A roadway simulator comprising:
a first roller;
a second roller spaced from the first roller;
a continuous belt positioned about the first roller and the second roller, the continuous belt having an outer surface and an inner surface;
an energy source configured to impart energy into the continuous belt to heat or cool the continuous belt;
a temperature sensor configured to provide a signal relating to a sensed temperature of the continuous belt; and
a controller configured to receive the signal from the temperature sensor, determine an error between the sensed temperature on the continuous belt and a setpoint and send a signal to the energy source to adjust an amount of heat imparted into the continuous belt based upon the error.

2. The roadway simulator of claim 1, wherein the energy source comprises a heat source configured to direct heated air directed toward the continuous belt to convectively heat the continuous belt.

3. The roadway simulator of claim 1, and further comprising:
an air bearing located between the first roller and the second roller and below the inner surface of the continuous belt, wherein heated or cooled air is directed through the air bearing to convectively heat or cool the continuous belt.

4. The roadway simulator of claim 1, and wherein the energy source comprises a radiant heater configured to direct radiant energy toward the continuous belt.

5. The roadway simulator of claim 4, wherein the radiant heater comprises an infrared heater configured to direct radiant energy towards the inner or outer surface of the continuous belt.

6. The roadway simulator of claim 1, wherein the energy source is located within the first roller and/or the second roller, wherein the energy source is configured to heat the first roller and/or the second roller, wherein the continuous belt is heated through conduction due to contact with the first roller and/or the second roller.

7. The roadway simulator of claim 1, and further comprising:
a water/glycol bearing located between the first roller and the second roller and below the inner surface of the continuous belt, wherein heated water is directed through the water/glycol bearing to convectively heat the continuous belt.

8. The roadway simulator of claim 1, wherein the temperature sensor is embedded or attached to the continuous belt.

9. The roadway simulator of claim 1, wherein the temperature sensor comprises a non-contact sensor configured to sense a temperature of the continuous belt.

10. A method of simulating a heated roadway, the method comprising:
providing a continuous belt supported by a first roller such that the continuous belt moves about the first roller and a spaced apart second roller;
positioning at least a portion of a vehicle over the continuous belt;
heating or cooling the continuous belt to a selected temperature;
rotating the continuous belt to simulate movement of the vehicle along a road at a selected speed at the selected temperature; and
monitoring one or more parameters of the vehicle due to the presence of the heated continuous belt.

11. The method of claim 10, wherein the selected elevated temperature ranges between about 120°F and about 140°F.

12. The method of claim 10, wherein the selected temperature is cooled below ambient temperature to simulate cold weather road conditions.

13. The method of claim 10, wherein heating the continuous belt comprises directing heated or cooled fluid towards the continuous belt to convectively heat or cool the continuous belt.

14. The method of claim 13, wherein heating the continuous belt comprises directing heated fluid towards the continuous belt through a bearing located between the first roller and the second roller and below the continuous belt.

15. The method of claim 13, wherein cooling the continuous belt comprises directing cooled fluid towards the continuous belt through a bearing located between the first roller and the second roller and below the continuous belt.

16. The method of claim 10, wherein heating the continuous belt comprises directing radiant energy toward the continuous belt.

17. The method of claim 10 and further comprising:
sensing a temperature of the continuous belt with a sensor;
comparing the temperature to the selected temperature; and
adjusting an amount of heat imparted into the continuous belt based upon the comparing the temperature to the selected temperature.

18. The method of claim 17, wherein sensing the temperature of the continuous belt comprises:
embedding or attaching a sensor to the continuous belt; and
sending a wireless signal relating to the temperature to a controller to compare the temperature to the selected temperature.

19. The method of claim 17, wherein sensing the temperature of the continuous belt comprises:
utilizing a non-contact temperature sensor to determine a sensed temperature of the continuous belt; and
sending a signal relating to the temperature to a controller to compare the sensed temperature to the selected temperature.
